(19) United States
(12) Patent Application Publication
(10) Pub. No.: US 2008/0019138 A1
(43) Pub. Date: Jan. 24, 2008

(54) Reflector having a prismatic structure

(75) Inventors: Andreas Otte, Alfeld (DE); Steffen Koerner, Delligsen (DE); Eberhard Kurek, Kalefeld-Sebexen (DE); Michael Heinen, Seesen (DE); Ralf Becker, Bad Gandersheim (DE)

Correspondence Address: DEMONT & BREYER, LLC, 100 COMMONS WAY, Ste. 250, HOLMDEL, NJ, 07733, US

(73) Assignee: SCHOTT AG, Mainz (DE)

(21) Appl. No.: 11/775,441

(22) Filed: Jul. 10, 2007

(30) Foreign Application Priority Data
Jul. 21, 2006 (DE) 10 2006 034 324.7
Jul. 21, 2006 (DE) 20 2006 011 397.5

(51) Int. Cl. F21V 13/04; F21V 7/06; F21V 7/08

(52) U.S. Cl. 362/327; 362/348

(57) ABSTRACT

The invention relates to a reflector having reflection prisms that has a holder for a luminous means, and to a luminaire in the case of which the reflector is permanently connected to the luminous means.

### FIELD OF THE INVENTION

The invention relates to a prismatic reflector and to a luminaire having a prismatic reflector.

### BACKGROUND OF THE INVENTION

Prismatic reflectors are known. Thus, for example, German Imperial Patent No. 554 562 exhibits a lamp bell for streetlamps that is partially fitted with prismatic reflectors.

It has proved to be disadvantageous of such prismatic reflectors that they mostly have an excessively low efficiency, that is to say a large part of the light emitted by a lamp is not reflected, but leaves the reflector at its rear side.

It is particularly disadvantageous of such prismatic reflectors that even slight displacements of the luminous means relative to the reflector can result in a greatly reduced efficiency.

Furthermore, there are also known from practice reflectors that are provided with a reflecting coating instead of reflection prisms. Such a reflecting coating is expensive to produce and can tend to flake off. This tendency to flake off is intensified, in particular, by high thermal stressing of the reflector in conjunction with powerful luminous means, for example in digital projectors (beamers) and vehicles.

### OBJECT OF THE INVENTION

By contrast, it is the object of the invention to provide a reflector in the case of which said disadvantages of the prior art are reduced.

In particular, it is an object of the invention to make available a luminaire that is provided with a prismatic reflector and has an improved efficiency.

Furthermore, it is an object of the invention to make available a luminaire that can be used for interior lighting, in particular provided with halogen incandescent bulbs, and has a high efficiency.

Furthermore, it is an object of the invention to make available an easily exchangeable combination of reflector and luminous means that can be used both for pure illumination tasks and for digital projectors.

### SUMMARY OF THE INVENTION

The object of the invention is already achieved by a reflector and by a luminaire as claimed in one of the independent claims.

Preferred embodiments and developments of the invention are to be gathered from the respective subclaims.

In accordance with the invention, a reflector is provided that comprises a holder for a luminous means and has a main element that is provided at least in sections with reflection prisms.

A good adjustment of the luminous means is achieved through the integration of the holder for the luminous means in the reflector. In addition, it is possible to make available an easily exchangeable combination of luminous means and reflector that is a unit which can easily be exchanged and is, in particular, also suitable for digital projectors and halogen reflectors for lighting interiors.

According to a preferred embodiment of the invention, the main element of the reflector is substantially of rotationally symmetrical design.

Provided in particular for digital projectors is a parabolically configured main element that essentially produces a parallel light emission.

Alternatively, the main element can also be of elliptical design, it thereby being possible to make a spotlight available.

Other configurations can, however, also be provided particularly for lighting tasks in interiors. In this case, reflectors with an aperture angle between 10° and 60° are provided.

In order to attain a good efficiency, the reflection prisms preferably run in substantially radial fashion from the holder for the luminous means, that is to say the reflection prisms extend outwards in a substantially star shaped fashion from a center of the reflector and in so doing simultaneously run in a substantially tangential fashion to the inside surface of the reflector main element.

In a preferred embodiment of the invention, the reflector is of unipartite design. Thus, the reflector can be made available as a pressed glass part, for example.

Alternatively, it is also possible to consider a transparent plastic as material, although glass exhibits the higher optical quality and a higher thermal stability for most applications.

The reflector main element preferably has between 10 and 100, and with particular preference between 20 and 25 reflection prisms. It has emerged that a particularly good efficiency is yielded with a number of approximately 30 reflection prisms in conjunction with a reflector having a halogen luminous means.

The reflector main element, which is preferably of rotationally symmetrical design, has a diameter of between 10 and 15 cm, preferably between 2 and 10 cm, and with particular preference between 3 and 6 cm.

In particular, reflectors fitted with halogen luminous means and having a diameter of approximately 50 mm are provided. The inventor has found that even relatively small reflectors can be made available as prismatic reflectors of acceptable efficiency.

The reflection prisms have at the tip an edge radius of less than 0.3 mm, preferably less than 0.1 mm, and with particular preference less than 0.05 mm. The efficiency of the reflector is reduced by means of such a small edge radius.

In a corresponding way, the edges at the transitions of the individual reflection prisms are also configured with an edge radius of less than 0.3 mm, preferably less than 0.1 mm, and with particular preference less than 0.05 mm.

In one development of the invention, the reflection prisms emanate in a substantially radial fashion from the holder for the luminous means, and are twisted in each case from one end to the other end between 1 and 20°, preferably between 2 and 10°. The reflection prisms thus do not run exactly in a star shaped fashion, but it is provided to twist them between 4 and 6°, in particular. This configuration leads to a more appealing optical appearance of the reflector.

In one development of the invention, the holder for the luminous means exhibits a fit for accurately adjusting the luminous means. The fit can be, for example, a cone or similar. For the purpose of the invention, fit is understood as any desired means which ensures that the luminous means are inserted in a defined position.

Thus, upon insertion of the luminous means or upon exchange of the luminous means the position is prevented from deviating from the desired position, since in the case of the inventive prismatic reflector it is possible for the efficiency to be greatly impaired by an inaccurate adjustment of the luminous means.

In one development of the invention, the inside surface of the reflector main element is structured at least in sections. In particular, the inside surface of the reflector main element is provided with facets.

It has turned out in this case that in particular light collecting structures such as, for example, cylindrical lenses curved along the surface improve the efficiency of the reflector.

Faceting that, owing to a refraction of the light emitted by the luminous means, achieves a diffraction of beams in the direction of an axis running perpendicular to the reflection prism also improves the efficiency of the reflector.

Alternatively, the inside surface of the reflector can also be of smooth configuration.

The invention relates, furthermore, to a luminaire that is configured with an inventive reflector.

The luminaire comprises a luminous means that is preferably adjusted and fastened in the reflector.

In particular, the luminous means can be glued in or cast in.

Such a configuration makes available a compact, exchangeable luminous means in the case of which the reflector is exchanged together with the incandescent bulb.

Depending on the type of lamp used, it is possible in this case to provide the reflector with a cover plate that in particular absorbs UV radiation.

However, the cover plate can also serve as shatter guard, particularly in the case of digital projectors.

The inventive luminaire is designed in such a way that the ratio of forward emitted light to backward emitted light is more than 1.5, preferably more than 1.8, and with particular preference more than 2.2.

Thus, a luminaire that emits more than ⅔ of the light forward is made available.

A halogen lamp is preferably used as luminous means.

The invention is provided, in particular, for digital projectors, in the case of which use is made of luminous means having a very high light output and, in association therewith, mostly generating a very high heat quantity.

Use in vehicle headlights is also provided.

### BRIEF DESCRIPTION OF THE DRAWINGS

The invention is to be explained in more detail below with the aid of the drawings, namely FIG. 1 to FIG. 7, in which:

FIG. 1 shows a partially cut away side view of an exemplary embodiment of an inventive reflector,

FIG. 2 shows a sectional view of an inventive reflector,

FIG. 3 shows a schematic view of the rear side of an inventive reflector,

FIG. 4 shows a plan view of an exemplary embodiment of an inventive reflector,

FIG. 5 shows a plan view of an alternative embodiment of a reflector,

FIG. 6 shows an exemplary embodiment of an inventive luminaire, and

FIG. 7 shows a schematic view of a detail of an inventive reflector in accordance with FIG. 3.

### DETAILED DESCRIPTION OF THE DRAWINGS

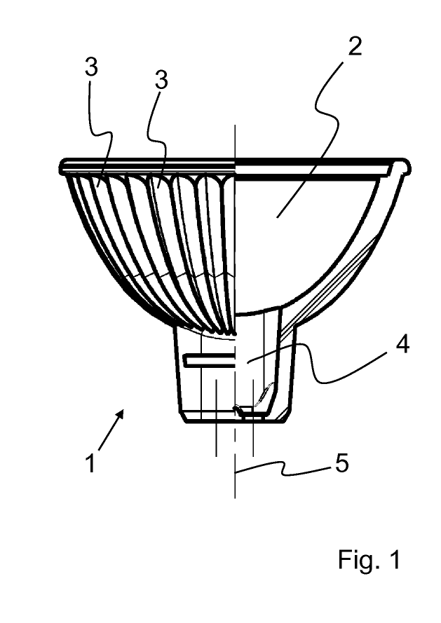

Referring to FIG. 1, the aim is to explain in more detail the essential features of an exemplary embodiment of an inventive reflector 1. The reflector 1 comprises a main element 2 and a holder for a luminous means 4. The main element 2 is substantially of rotationally symmetrical design about a rotation axis 5.

The holder for the luminous means 4 is located at the base of the main element 2 and is, for its part, not of rotationally symmetrical design.

The right hand side of the reflector 1 is cut away in this illustration. Visible on the left hand side of the reflector are the reflection prisms 3, which emanate in a substantially radial fashion from the holder for the luminous means 4, and run upward in a star shaped fashion.

The reflector 1 consists of pressed glass and is preferably fitted with a halogen luminous means (not illustrated).

The reflector 1 has approximately 30 reflection prisms 3. The reflection prisms 3, which run in a star shaped fashion around the rotation axis 5, substantially follow the inclination of the main element 2.

In order to achieve a higher efficiency, it is also possible to deviate in sections from this essentially tangential course (not illustrated).

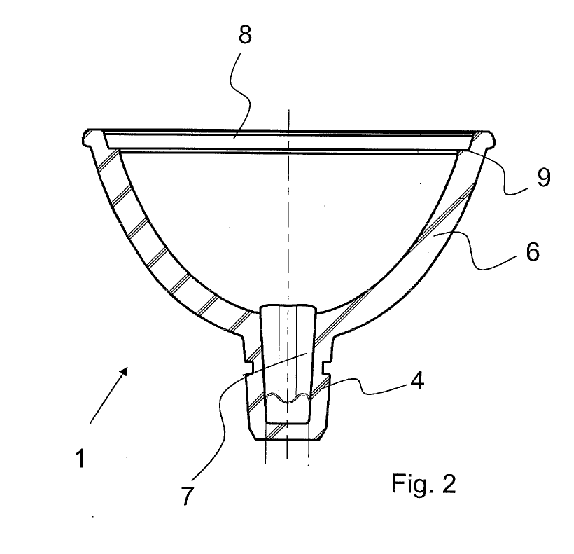

FIG. 2 shows a schematic sectional illustration of an exemplary embodiment of an inventive reflector. This sectional illustration particularly depicts the glass walls 6 of the main element, which merge seamlessly into the holder of the luminous means 4.

The reflector is therefore of unipartite design. The holder for the luminous means 4 has an essentially conically tapering fit 7. This ensures that the luminous means (not illustrated) is arranged in a defined position.

The reflector 1 is provided on the light exit side with a cover plate 8 that is glued onto a circumferential web. The cover plate 8 is constructed from a UV absorbing material, and serves simultaneously as shatter guard.

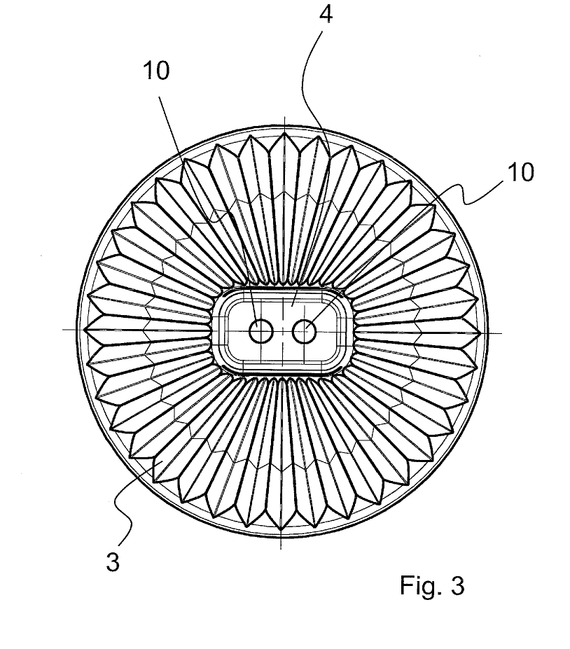

FIG. 3 shows a schematic view of the rear side of an exemplary embodiment of an inventive reflector 1. Visible in particular are the 30 reflection prisms 3 that run in a star shaped fashion around the holder for the luminous means 4.

The holder for the luminous means has two bushings 10 for the contacts of the luminous means (not illustrated). When equipped with a luminous means (not illustrated), the reflector can then be inserted into a lamp (not illustrated).

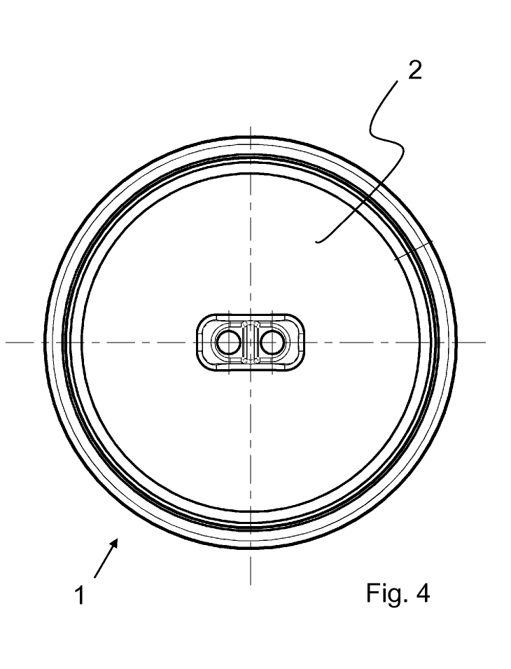

FIG. 4 shows a plan view of the front side of an exemplary embodiment of an inventive reflector. The main element 2 of the reflector is of smooth design in this exemplary embodiment, and so the light beams (not illustrated) can pass through the smooth surface into the reflection facets.

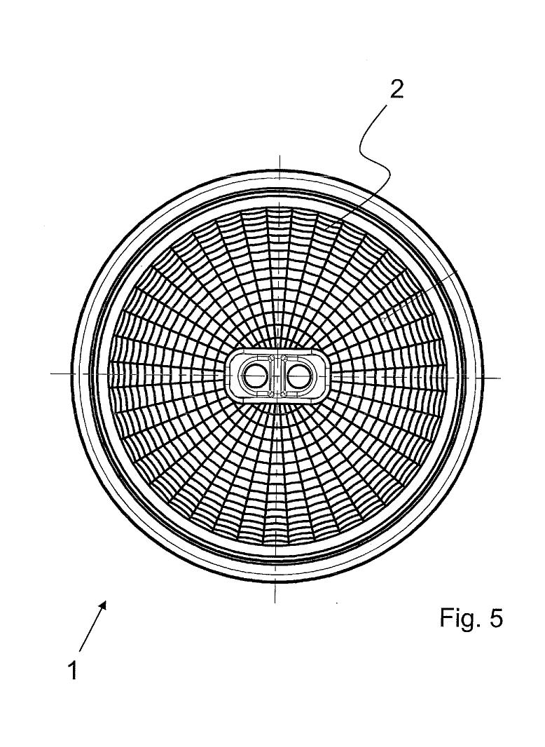

FIG. 5 shows an alternative embodiment of the reflector 1, in which the inside surface of the reflector main element 2 is provided with facets. The light beams (not illustrated) can be specifically aligned in the direction of the normals to the reflection prisms via the facets.

The efficiency is further improved when the facets are designed as curved cylindrical lenses.

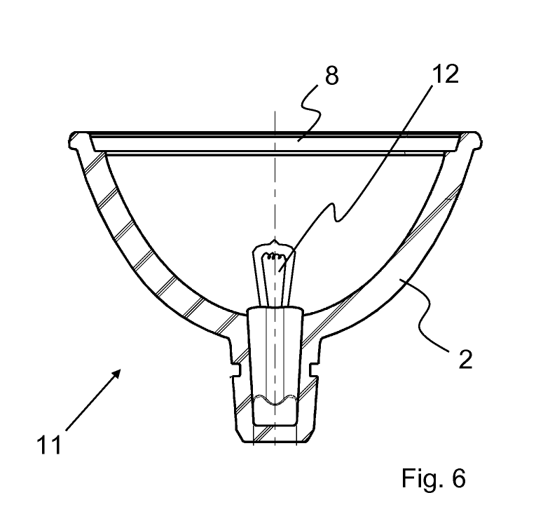

FIG. 6 shows a schematic exemplary embodiment of an inventive luminaire 11. The luminaire 11 comprises a reflector 2, in which a luminous means 12, configured here as a halogen lamp, is glued. The luminous means is thus optimally positioned in order to achieve an optimum efficiency of the reflector 2.

A cover plate 8 prevents the emergence of UV radiation, and simultaneously serves as shatter guard.

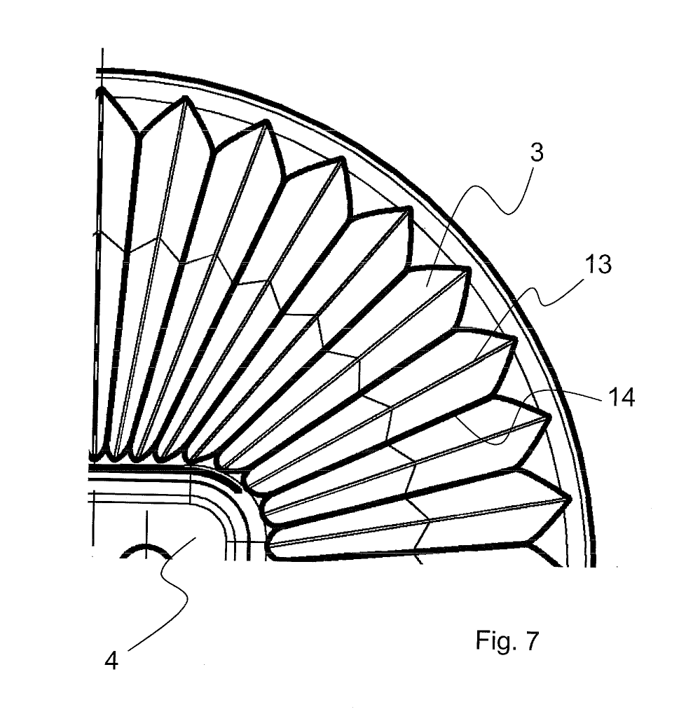

Referring to FIG. 7, which shows a view of a detail of an exemplary embodiment of a reflector, the aim is to explain the geometry of the reflection prisms 3 in more detail. The reflection prisms 3, which emanate in a star shaped fashion from the holder for a luminous means 4 have at the tips 13 an edge radius of less than 0.3 mm. The same holds for the transition edges 14 between the individual reflection prisms.

The reflection prisms 3 have a tip angle, that is to say an angle at the tip 13, of 90°.

It goes without saying that the invention is not limited to a combination of the previously named features, but that the person skilled in the art will combine all the named features to a sensible extent.

### List of Reference Numerals

1 Reflector
2 Main element
3 Reflection prism
4 Holder for luminous means
5 Rotation axis
6 Glass wall
7 Fit
8 Cover plate
9 Web
10 Bushing
11 Luminaire
12 Luminous means
13 Tip
14 Transition edge

1. A reflector comprising at least one holder for at least one luminous means, the reflector having a main element that is provided at least in sections with reflection prisms.

2. The reflector as claimed in claim 1, wherein the main element is substantially of rotationally symmetrical design.

3. The reflector as claimed in claim 2, wherein the main element is substantially of parabolic design.

4. The reflector as claimed in claim 2, wherein the main element is substantially of elliptical design.

5. The reflector as claimed in claim 1, wherein the reflection prisms emanate in a substantially radial fashion from the holder for the luminous means.

6. The reflector as claimed in claim 1, wherein the reflector is of unipartite design.

7. The reflector as claimed in claim 1, wherein the reflector consists of glass.

8. The reflector as claimed in claim 1, wherein the reflector main element has between 10 and 100, reflection prisms.

9. The reflector as claimed in claim 1, wherein the reflector main element has a diameter of between 1 and 15 cm.

10. The reflector as claimed in claim 1, wherein the reflection prisms at least partially have at the tip an edge radius of less than 0.3 mm.

11. The reflector as claimed in claim 1, wherein the reflection prisms emanate in a substantially radial fashion from the holder for the luminous means, and are twisted in each case from one end to the other end between 1° and 20°.

12. The reflector as claimed in claim 1, wherein the reflector main element is substantially of rotationally symmetrical design and has an aperture angle between 10° and 60°.

13. The reflector as claimed in claim 1, wherein the holder for the luminous means exhibits a fit for accurately adjusting the luminous means.

14. The reflector as claimed in claim 1, wherein the inside surface of the reflector main element is structured at least in sections.

15. The reflector as claimed in claim 1, wherein light collecting structures are arranged on the inside surface of the reflector main element at least in sections.

16. The reflector as claimed in claim 1, wherein refractive structuring is arranged on the inside surface of the reflector main element at least in sections.

17. The reflector as claimed in claim 1, wherein the refractive structuring is designed in such a way that beams emanating from a light source are deflected at least in sections in the direction of an axis running perpendicular to the reflection prism.

18. The reflector as claimed in claim 1, wherein the inside surface of the reflector is smooth at least in sections.

19. A luminaire comprising a reflector as claimed in claim 1, and at least one luminous means.

20. The luminaire as claimed in claim 19, wherein the luminous means is adjusted and fastened in the reflector.

21. The luminaire as claimed in claim 20, wherein the luminous means is glued or cast in the reflector.

22. The luminaire as claimed in claim 19, wherein the reflector has a substantially rotationally symmetrical main element that is provided with a cover plate that absorbs UV radiation.

23. The luminaire as claimed in claim 19, wherein the ratio of forward emitted light to backward emitted light is more than 1.5.

24. The luminaire as claimed in claim 19, wherein the luminous means is a halogen lamp.

25. A lamp for a digital projector, comprising a luminaire as claimed in claim 19.

26. A lamp for a motor vehicle comprising a luminaire as claimed in claim 19.
